(19) United States
(12) Patent Application Publication
(10) Pub. No.: US 2011/0282860 A1
(43) Pub. Date: Nov. 17, 2011

(54) DATA COLLECTION, TRACKING, AND ANALYSIS FOR MULTIPLE MEDIA INCLUDING IMPACT ANALYSIS AND INFLUENCE TRACKING

(75) Inventors: David W. Baarman, Fennville, MI (US); Patrick Burrell, Allendale, MI (US); Thomas Jay Leppien, Grand Haven, MI (US); Brian B. Steketee, Grand Rapids, MI (US); David M. Baarman, Fennville, MI (US)

(73) Assignee: ACCESS BUSINESS GROUP INTERNATIONAL LLC, Ada, MI (US)

(21) Appl. No.: 13/108,691

(22) Filed: May 16, 2011

Related U.S. Application Data
(60) Provisional application No. 61/345,127, filed on May 16, 2010.

(51) Int. Cl. G06F 17/30

(52) U.S. Cl. 707/709; 707/E17.108

(57) ABSTRACT

A system is disclosed for data collection, media analysis, and web tracking. The collected data may include a broad search for a reference database and a narrow search for a comparative database. A contact relationship management database is used to store and distribute profiles for individuals and companies. An RSS feed database may update frequently and provide relevant search results. The system may analyze the collected data and tracking of that data. Analysis may be used to identify relevant data. Profiling of users and businesses may be used for targeting and generating profile data that may include specific information for a user or business. Monitoring and/or tracking may be used for identifying changes in data. The system may provide an analysis of impact of an event/source based on user impressions or web hits in view of a particular event/source. The impact may include a social influence value. In another embodiment, a return on investment (“ROI”) in view of the influence is provided.

### PRIORITY

This application claims priority to U.S. Provisional App. No. 61/345,127, entitled “DATA COLLECTION, TRACKING, AND ANALYSIS FOR MULTIPLE MEDIA INCLUDING IMPACT ANALYSIS AND INFLUENCE TRACKING,” which was filed on May 16, 2010, and is hereby incorporated by reference.

### BACKGROUND

Internet or network tracking of data, events, or individuals, such as the proliferation of that concept through the Internet, is generally limited to internet service providers (“ISPs”) and may further be limited to the use of tags for items to be monitored and tracked. Image searches have been limited to text searches that return associated graphic or media elements that are associated with the searched text. The tracking of the proliferation of an idea, press release, event, or media release may be difficult because of the amount of data on the Internet. The size of the Internet also makes it difficult to identify relevant material and analyze that material. When the analysis includes a determination of relevance or influence, it is generally limited to a manual and subjective review. This may be further complicated by the complexities and size of large corporations. The number of searches and terms from many employees can yield different results across the organization. It may be helpful to be able to identify better modes, terms, and information available to all employees to limit potential misinformation. Having a system that builds better methods and search terms and organizes them as a sum of the whole may improve a search for relevant data when using this information.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates a general overview of the tracking and analysis;

FIG. 2 illustrates a simplified block diagram of an exemplary network system;

FIGS. 3a and 3b illustrates a system for collecting, tracking, analyzing, and determining the impact for a particular event;

FIG. 4 illustrates the requesting of data for an event and the generation of the reference database;

FIG. 5 illustrates how media and text are analyzed using crawler data;

FIG. 6 illustrates a text, logo, or image marker can be used for a comparison;

FIG. 7 illustrates an audio analysis using audio patterns;

FIG. 8 illustrates references between languages, images, text, and audio;

FIG. 9 illustrates database comparison to an initial set of data.

FIG. 10 illustrates the use of a contact relationship management (“CRM”) database;

FIG. 11 illustrates resources used to validate the social expertise, and CRM data for valuing and influence;

FIG. 12 illustrates the collection of targeting data as well as the analysis and valuing of contact information;

FIG. 13 illustrates how images can be converted into useful data;

FIG. 14 illustrates the return on investment engine;

FIG. 15 illustrates a visualization of impact analysis;

FIG. 16 illustrates items in context can be used to track the success of an event or series of events;

FIG. 17 illustrates a visualization of impact analysis;

FIG. 18 illustrates a process for collecting additional data;

FIG. 19 illustrates an exemplary process;

FIG. 20 illustrates exemplary media types;

FIG. 21 illustrates exemplary data analysis; and

FIG. 22 illustrates development of common terms for a corporation.

### DETAILED DESCRIPTION

By way of introduction, the disclosed embodiments relate to organizing and collecting a body of search terms for an organization in an organized way for searching, tracking, and providing an analytic analysis on the proliferation or success of single or multiple searchable elements including multiple media formats. The searchable elements may include a particular event, which may include a show, press release, article, web page, product, or other discrete happening. Events may also be segmented by categories. For example, categories may include social responsibility, emotional appeal, vision and leadership, financial performance, workplace environment or products and services. Events may include pictures, videos, web media, blog conversations, emails, RSS feeds, web objects, and other networked information source that may be searchable or connected. This may be relevant as the internet becomes the most important source of media to track and analyze the success of an event. The success may be measured by a return on investment (“ROI”) of these events, which may allow for proper investment of marketing dollars to maximize exposure while minimizing spending. This impact analysis may be used for research, sales, human resources, marketing, market research, public relations, legal, brand tracking, consumer research, etc. These potential objectives are different rationales for searching that may utilize different ROI analysis based on the particular requirements for each objective.

The collection of data repositories/servers, connections and users within the Internet are dynamic. Content is added, replicated, modified, and deleted. Internet search engines periodically crawl the Internet and develop indices which may be static snapshots of the Internet at the time of the crawl. The present embodiments relate to systems and methods for capturing, analyzing and reporting on the dynamic nature of the Internet and provides methodology by which changes may be detected and reported, in particular with respect to changes sparked by one or more particular events. In this way, ideas or events, and in particular, content expressing or describing an idea or event, may be tracked from the first introduction of such content, as the content is replicated, modified or appended or as derivative content based thereon is added, replicated, modified or appended, etc., across connections and data repositories. The ideas or events that are tracked and analyzed may include companies, products, people, activities, or other concepts that may be found on the Internet.

In one embodiment, the introduction of a commercial brand may be tracked, such as from the time it is first publicly displayed. The tracking may include monitoring the Internet for traffic and mentions of the brand. Data may be dynamically collected for tracking of brand awareness and public impressions. The proliferation of content related or describing the brand may be tracked to assess commercial impact or effectiveness of the brand. An analysis of sources of proliferation may be used to further determine impact. For example, profiles (of businesses or individuals) may be used to determine the potential value of sources and to quantify an impact from these sources.

The disclosed embodiments may further include the generating and collecting of data, including tracking data. The collected data may be analyzed and updated. The analysis may include data aggregation, content matching, user tracking, and identifying relevant data and further data that should be collected. An additional analysis may be performed to quantify the success or impact of the collected data.

The disclosed embodiments further disclose a system that performs a matching of text quotes, audio confirmation of sound bytes, and image confirmation in graphics, video or other graphic media. This content matching is used to compare and match reference media with a large set of media. The reference media may include articles about a recent event, or a picture of a product. This system may use voice recognition software along with image analysis software capable of analyzing pictures, graphic files and video files, as well as text searching. Using a reference database of text, quotes, images, audio, and video the system looks for matches that are aligned with events from the reference database. For simplicity, the system will be described as tracking and analyzing an event, but an event may also include a show, press release, product release, company restructuring, promotion, product preview, article, web page, product, or other discrete happening. It can also be used to track specific trends, technologies, competitive companies, brands and more. The system uses crawlers to define areas of usage by the reference database. Collected data may then be stored in a search database, such as a list with search results. These search results may be referenced by type (e.g. text, graphic type, picture, audio, picture, internet service provider (“ISP”), internet protocol (“IP”) address, etc.), date, or other data related to the results. Another search database may be maintained with the links to the references listed above. Once the search list has been completed, another confirmation engine may process the text, along with a digital analysis on the audio, video and images. Each confirmation is then stored within the first reference database and each set of search references are related to an event. These can be tracked with the final analysis and confirmation of the search. The data forms a history by event over time to determine the ongoing activity, impact, impressions, links, or link types that have influence or valuing associated with them for an ROI analysis.

The system may use the context of multiple items to develop a better picture of identified relevant data. The system can mine deeper using that information to gain additional insight. Using text, images, networking details, sentiment, video, or audio, the system can build a very specific footprint of activity. Sentiment may be an attitude, thought, or judgment prompted by a prediction. For example, the categories listed above may be used, as well as a particular sentiment dictionaries. Sentiment dictionaries may be readily available as standard judgments in society which have been predetermined. In one embodiment, a subjectivity calculation may be made by the following calculation:

Relevance_subjectivity=positive_references/total_references.

Topic_subjectivity=topic_score/total references.

Target_proximity=proximity_score/total references.

Relevance=Relevance_subjectivity+Topic_subjectivity+Target_proximity.

This may be used for each respective reference to complete a total relevance for sentiment. Additional categories as listed above may also be scored to show relative performance in specific groupings or categories of tracking or monitoring. Additionally the characters of the impressions and the influencers can be built out by reaching deeper into the value of the web input they contributed and/or influenced. An influencer score may be included that can be analyzed by each respective tracking. The impact analysis of any event may be measured and monitored. In particular, the impact may include further data mining for sources that have the highest impact.

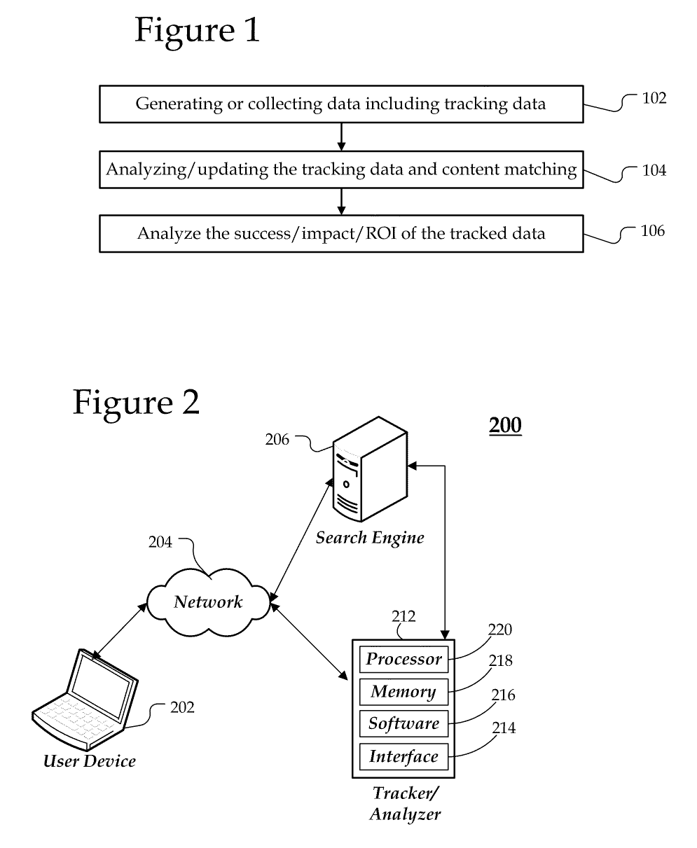

FIG. 1 illustrates a general overview of the tracking and analysis. In block 102, data is collected and/or generated. The collected data may include tracking data. As discussed below, the system generates databases (e.g. reference databases, social contacts database, social contacts database, etc.) and collects data. In block 104, the collecting data is analyzed and monitored. The analysis includes identifying relevant data from the collected/tracking data, the profiling of users/businesses, the continued monitoring of a business, and/or content/source tracking. The identifying of relevant data may include content matching. In block 106, the collected data (including tracking data) is analyzed to determine the success or impact or return on investment (ROI) of the collected data. This analysis may include a social value or an influencer value for determining the value of a particular source of data.

FIG. 2 depicts a simplified block diagram illustrating one embodiment of an exemplary network system 200. The network system 200 may provide a platform for the tracking and/or analysis of data discussed below. The network system 200 may include functionality for crawling the internet to collect and track data. In the network system 200, a user device 202 is coupled with a search engine 206 through a network 204. As described below, the search engine 206 may include or be coupled with a web server that distributes data from the network 204. A tracker/analyzer 212 may be coupled with the network 204 and/or the search engine 206. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 202 may be a computing device which allows a user to connect to a network 204, such as the Internet. Examples of a user device include, but are not limited to, a personal computer, personal digital assistant (“PDA”), cellular phone, or other electronic device. The user device 202 may be configured to allow a user to interact with the search engine 206, the tracker/analyzer 212, or other components of the network system 200. The user device 202 may include a keyboard, keypad or a cursor control device, such as a mouse, or a joystick, touch screen display, remote control or any other device operative to allow a user to interact with the search engine 206 and/or the via the user device 202. The user device 202 may be configured to access other data/information in addition to web pages over the network 204 using a web browser, such as INTERNET EXPLORER® (sold by Microsoft Corp., Redmond, Wash.) or FIREFOX® (provided by Mozilla). The data displayed by the browser may include requests for tracking data, data that is provided for analysis, and/or results for a data analysis. In an alternative embodiment, software programs other than web browsers may also display the data over the network 204 or from a different source.

The search engine 206 may provide a web page that is provided to the user device 202 and may be a search results page that is provided in response to receiving a search query from the user device 202. As discussed below the search query may be used for data tracking. In one embodiment, the search engine 206 may be or may be connected to a web server that acts as an interface through the network 204 for providing a web page to the user device 202. The search engine 206 may provide the user device 202 with any pages that include tracking requests from a user of the user device 202.

The tracker/analyzer 212 may be used to retrieve tracking data, or may be used to analyze available tracking data. The tracker/analyzer 212 may be a computing device for gathering tracking data or other media and/or analyzing that data or media. The tracker/analyzer 212 may include a processor 220, a memory 218, software 216 and an interface 214. As shown, the tracker and analyzer may be the same device, however; in different embodiments, the tracker and analyzer may be different devices and may or may not include all of the interface 214, the software 216, the memory 218, and/or the processor 220. The search engine 206 may be used to provide tracking data.

The interface 214 may be a user input device or a display. The interface 214 may include a keyboard, keypad or a cursor control device, such as a mouse, or a joystick, touch screen display, remote control or any other device operative to allow a user or administrator to interact with the tracker/analyzer 212. The interface 214 may communicate with any of the user device 202, the search engine 206, and/or the tracker/analyzer 212. The interface 214 may include a user interface configured to allow a user and/or an administrator to interact with any of the components of the tracker/analyzer 212. For example, the administrator and/or user may be able to review or update the requests for tracking data, the tracking data itself, the analysis of that data. The interface 214 may include a display coupled with the processor 220 and configured to display an output from the processor 220. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 220, or as an interface with the software 216 for providing data.

The processor 220 in the tracker/analyzer 212 may include a central processing unit (CPU), a graphics processing unit (GPU), a digital signal processor (DSP) or other type of processing device. The processor 220 may be a component in any one of a variety of systems. For example, the processor 220 may be part of a standard personal computer or a workstation. The processor 220 may be one or more general processors, digital signal processors, application specific integrated circuits, field programmable gate arrays, servers, networks, digital circuits, analog circuits, combinations thereof, or other now known or later developed devices for analyzing and processing data. The processor 220 may operate in conjunction with a software program, such as code generated manually (i.e., programmed).

The processor 220 may be coupled with the memory 218, or the memory 218 may be a separate component. The software 216 may be stored in the memory 218. The memory 218 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 218 may include a random access memory for the processor 220. Alternatively, the memory 218 may be separate from the processor 220, such as a cache memory of a processor, the system memory, or other memory. The memory 218 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 218 is operable to store instructions executable by the processor 220.

The functions, acts or tasks illustrated in the figures or described herein may be performed by the programmed processor executing the instructions stored in the memory 218. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 220 is configured to execute the software 216.

The present disclosure contemplates a computer-readable medium that includes instructions or receives and executes instructions responsive to a propagated signal, so that a device connected to a network can communicate voice, video, audio, images or any other data over a network. The interface 214 may be used to provide the instructions over the network via a communication port. The communication port may be created in software or may be a physical connection in hardware. The communication port may be configured to connect with a network, external media, display, or any other components in system 200, or combinations thereof. The connection with the network may be a physical connection, such as a wired Ethernet connection or may be established wirelessly as discussed below. Likewise, the connections with other components of the system 200 may be physical connections or may be established wirelessly.

Any of the components in the system 200 may be coupled with one another through a network, including but not limited to the network 204. For example, the tracker/analyzer 212 may be coupled with the search engine 206 and/or the user device 202 through a network. Accordingly, any of the components in the system 200 may include communication ports configured to connect with a network. The network or networks that may connect any of the components in the system 200 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

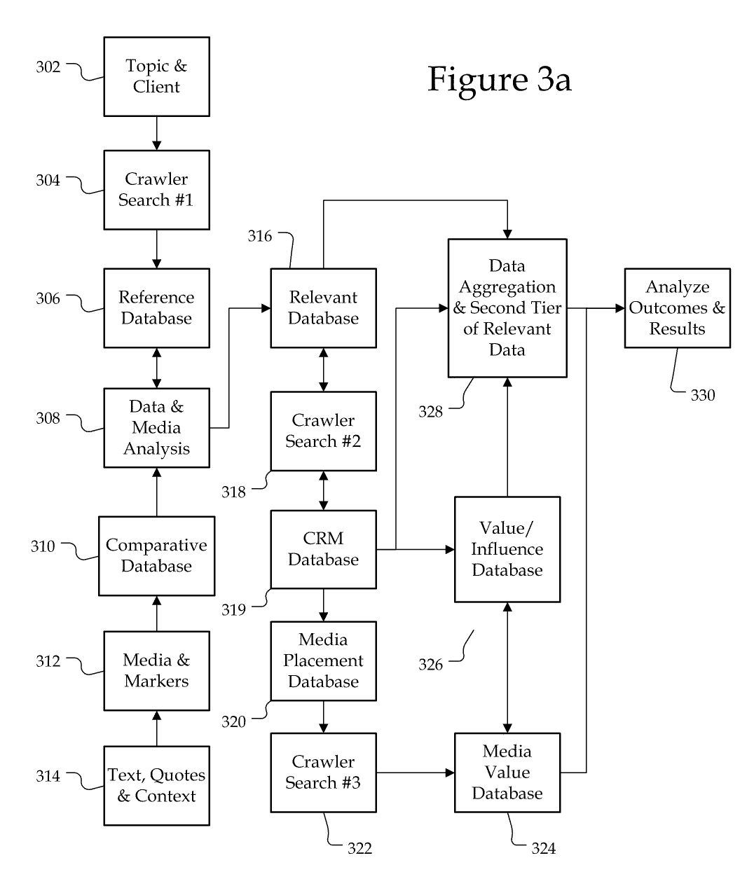

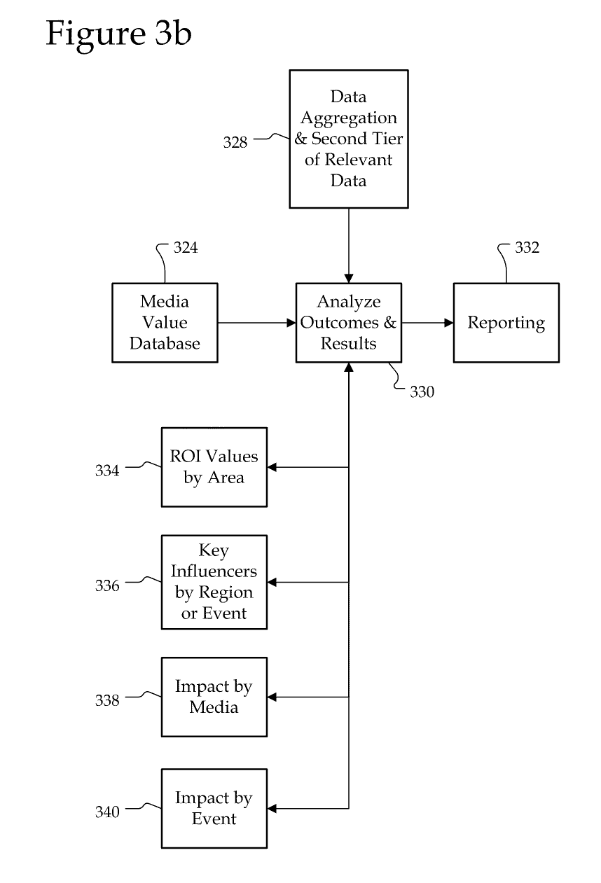

FIGS. 3a and 3b illustrate a system for collecting, tracking, analyzing, and determining the impact for a particular event. As described below, the system includes several data collection mechanisms (e.g. crawler searches), several databases for storing data (e.g. reference, comparative, media placement, media value, CRM, and value/influence databases), and mechanisms for further data analysis and impact analysis.

The topic and client information 302 includes a topic of interest, such as an event. The client information may include the searcher and information related to the searcher. That information may be used to focus the search. For searching on a particular topic, there is a first crawler search 304 that is used to create a reference database 306. The data in the reference database 306 may be considered first-pass data that can be further refined. The first crawler search 304 may be a common web search (e.g. GOOGLE, YAHOO, BING, etc.). Based off the information in the reference database, there may be text, quotes, and context 314 and images and markers 312 that are used with a comparative database 310. The text, quotes, and context 314 and other media and markers 312 may include examples of data that can be used to narrow down the reference database 306, and may be related to the topic and client 302. The comparative database 310 goes through a data and media analysis 308 to create a relevant database 316.

In one example, a domain, author, and other relevant data may be identified based on a story of interest. A second crawl may be executed at the command of the system (potentially automated) to go back to a particular source to pull additional information of interest. The additional information of interest may include text detail from the source, or it might include additional articles down from a similar domain to reference the context of the site, or images from that site that may be relevant to the initial collection from the source.

In another example, a first crawl identifies articles with negative discussions around a brand. A second crawl goes back to the article and collects additional articles from the site to identify the relevancy of the first article. Relevance may be a verification of context from cross referencing several words used in conjunction. For example, in the sentence: “A modern day marvel eCoupled brings wireless power to CES like a modern day worlds fair,” the use of “wireless power”, “eCoupled”, “modern, marvel”, “CES” may define relevance for a set of monitored terms. (EVENT) starts to define relevance for a specific set of monitored terms, A dictionary for the monitored set of terms may be set up as groupings or possible groupings. The more terms that are used in a specific paragraph the more relevant that specific paragraph becomes. Likewise, the frequency of the terms in a particular statement may also increase the relevance. The categories listed above may also be used for this relevancy determination. Partner lists and other specific dictionaries may define alternate groupings or classification scores for relative comparisons or scores. Another example is the second crawl is initiated to collect the article initially captured in full. This collection may be aided by an understanding or context of the organized data within the dictionary by specific groups and interests. Data collected for many groups may be cut by specific filters as listed above and organized to present or visualize depending on a specific interest. Consumer research compared with legal research may have differing reason for collecting similar data and may have different key words in the dictionary.

There may be several press releases related to the topic & client 302. In addition to press releases, other items related to the client may be gathered for the comparative database 310. The topic or client may include an item, company, or individual, including a representation of the topic or client, may be used to identify relevant media for which one uses to generate the comparative database 310. For example, a press release from a particular client may include quotes that are automatically identified as relevant because of an association to the client (e.g., the quote is an ad for the client, in which the quotes would be added to the comparative database 310). The data and media analysis 308 may compare the comparative database 310 to the reference database 306 that comes off the Internet. The search topic 302 is used to generate the reference database 306 using the first crawler search 304. The search topic 302 may include the text of the search, which may include a specific groupings of words. Alternatively, it may include a quote, whose usage is monitored. The data and media analysis 308 may be a series of dictionaries that are compared to the search material to classify its use, context and interest. The reference database 306 may be compared to a second group of information (comparative database 310) that is related to the desired search. This series of events may refine the classifications, scores and links to further define relevant data.

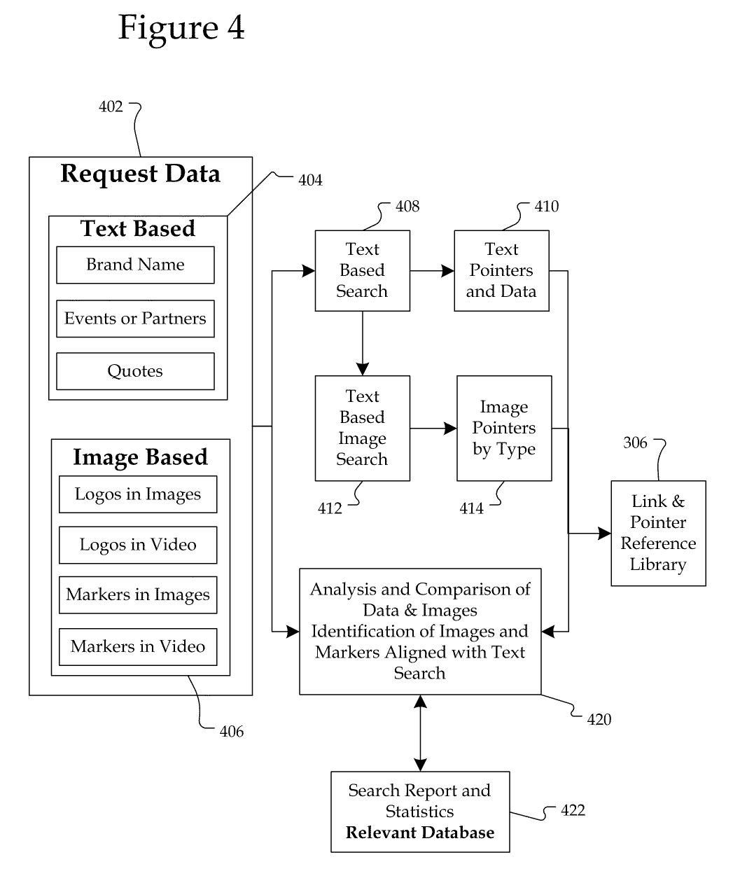

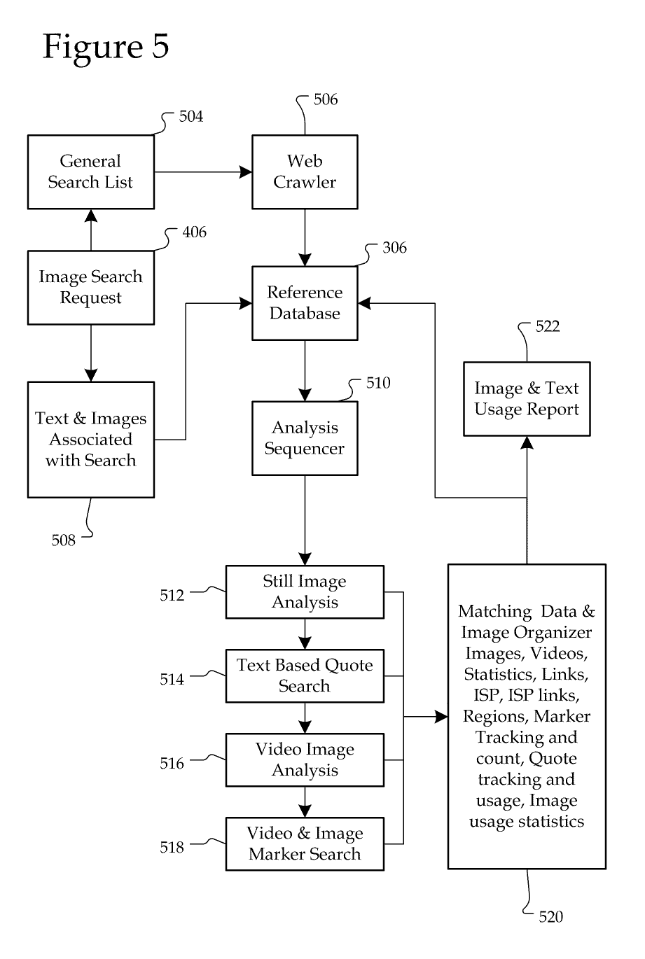

The reference database 306 is a gross list related to the topic 302. The gross list is compared with a comparative list from the comparative database 310 that includes additional data and images from the data and media analysis 308. For example, a user looking for an old apple computer picture would have a gross list including all images of all types of apples. The refinement of the gross list may include putting the apple logo as part of the comparative database 310. This context helps further narrow down the gross list in the reference database 306. The population and usage of the reference database 306 is further described in FIGS. 4-5.

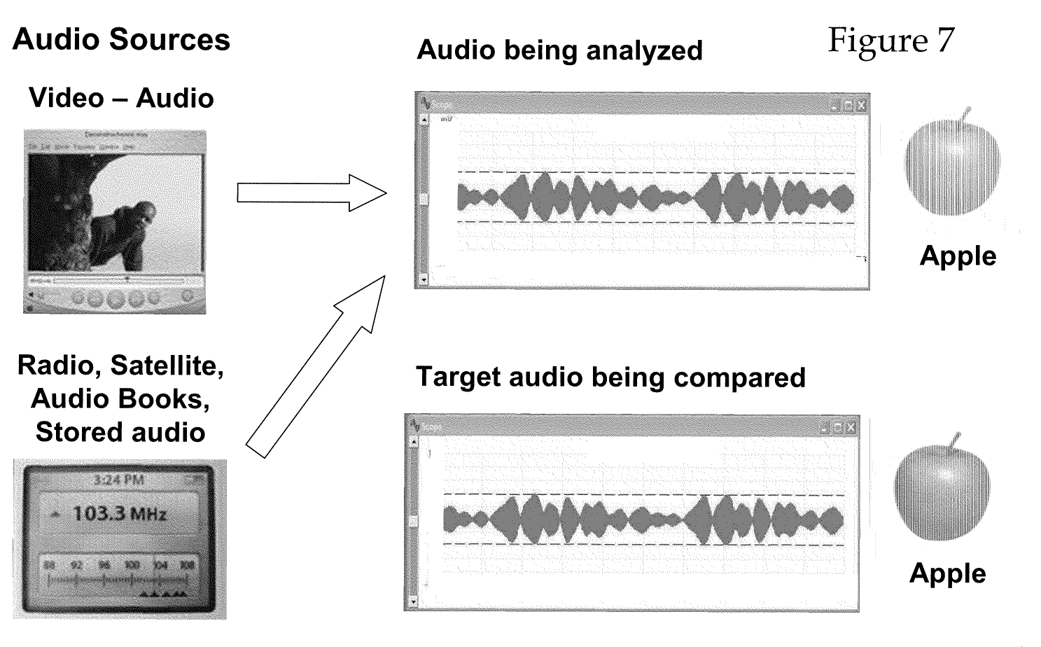

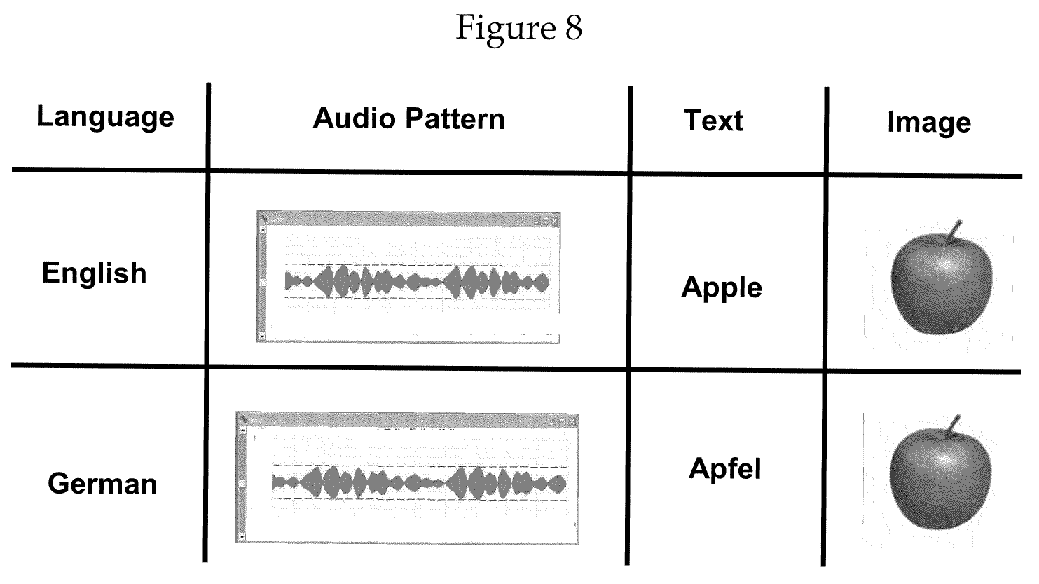

The reference database 306 might have a very large number of search results or hits, many of which may be irrelevant. The refinement of the reference database 306 with the analyzed comparative database 310 results in the relevant database 316. This refinement may be performed by the data and media analysis 308, which is further described with respect to FIGS. 7-8. Essentially this refinement is similar to the narrowing or refinement of search terms to identify relevant data; however, this refinement is performed in an automated fashion rather than as a manual process. The reference database 306 is an over-inclusive database that includes the results from the first crawler search 304, which is designed to provide a large number of search results. Accordingly, the reference dataset 306 has excessive information since much of the information may be irrelevant to the topic and client 302. The comparative database 310 is also a reference database, but it is used to narrow results based on examples of image and markers 312 or text, quotes, and context 314.

Generally, data from a reference database 306 is compared to data from a comparative database 310. That data is then analyzed to filter out any unrelated data to simplify subsequent data mining by the data and media analysis 308. The subsequent data mining may include an additional crawler step (second crawler search 318) for finding social links, sentiment, social influence, influence expertise, media placements (from the media placement database 320) and more. In some embodiments, the multiple crawler searches may be necessary for searching the web for more relevant data because of the size of the Internet. The searches may dig deeper using the reference data, terms, categories, and relevance dictionaries. These crawler search systems may automate this process. With that data another crawler (third crawler search 322) then searches media placement value and compiles a media value database 324 based on the cost per placement based on types, comparative costs, media costs, media timing, and associated influencers. In the third crawler search 322, a different series of information may be obtained. For example, the number of hits for a site (A vs B vs. C) may be determined. Alternatively, a number of followers, a number of blog entries may also be determined. By logging this data and comparing it in a relative or virtual form the relevance becomes even more pronounced with this influencer data. In alternative embodiments, the multiple crawler searches may be combined or automated in a such a way to reduce the number of searches.

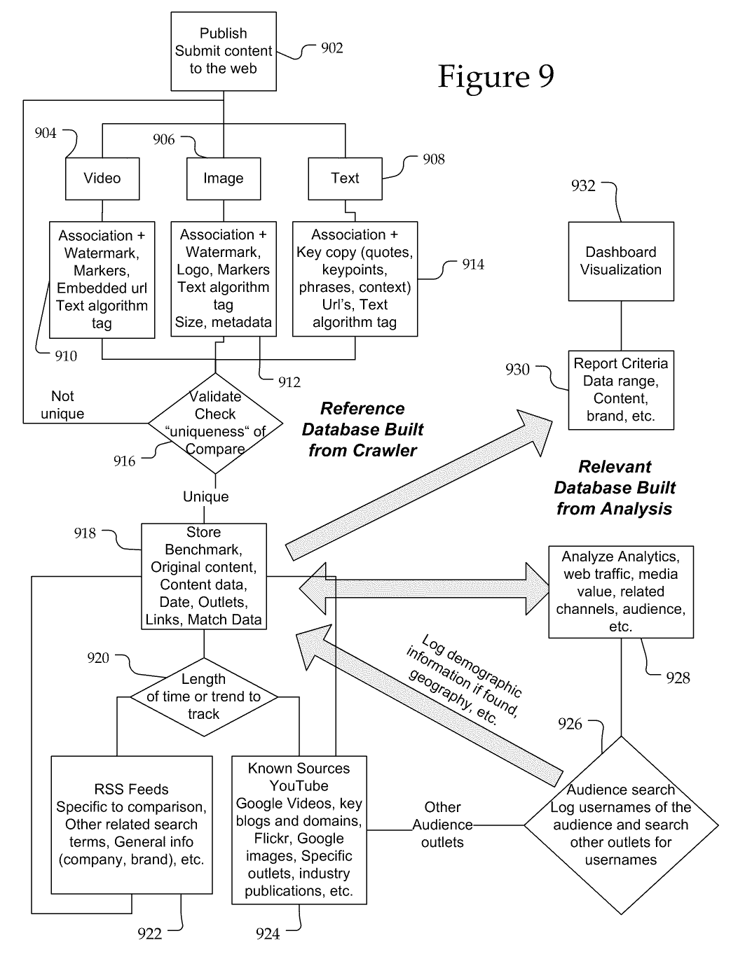

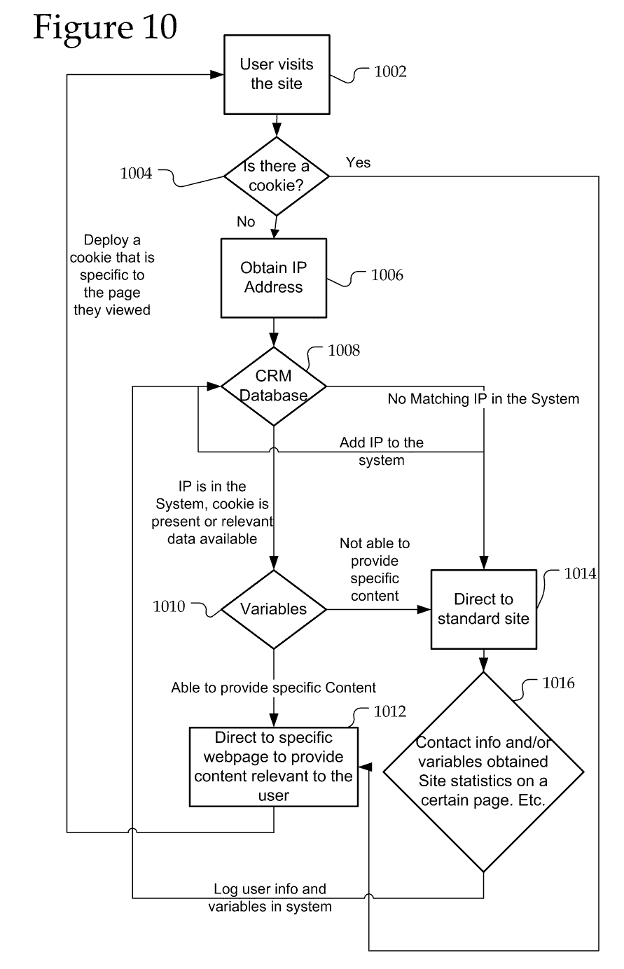

The relevant data is extracted to form the relevant database 316. The relevant database 316 is further referenced with respect to FIG. 9. Once the relevant data is identified, the second crawler search 318 is run. The second crawler search 318 searches on the relevant data. For example, a determination may be made about the author/owner of the relevant data. This may include coordination with the contact relationship management database 319. The CRM database 319 may include various data about individuals, businesses, or other sites, such as who they talk to, the type of media placement, and/or the social value/influence. The population of the CRM database 319 is discussed below with respect to FIG. 10. This information is relevant because a source with a high influence may have a very high impact. For example, an article by Steve Jobs will have a major impact in either a positive or negative way. A small-time blogger will have a much smaller impact. A source may refer to an author or owner of a search result, or may refer to a particular event. The CRM database 319 may record data about all contacts such as a determined impact or influence that may be quantified for that contact.

The media placement database 320 is relevant for identifying and recording the location of a particular event or location. Based on media placements, the impact may vary. For example, a source or interview on ABC news would have a large number of viewers and be a high influence source. Conversely, an interview for Joe Blow's Blog may have a low influence. For the placement on ABC, it may be worth a certain amount of placements and a certain amount of traffic on their website versus Joe Blow who's working from his basement. He is going to have a much less significant media placement or media value associated with his blog. Accordingly, the media placement database 320 may include a list of media and an estimated number of impressions for that particular media. This quantified influence may be directly related to the number of impressions. The media placement database 320 may be combined with the contact relationship management database 319, such that the contact relationship management database 319 includes media placement information.

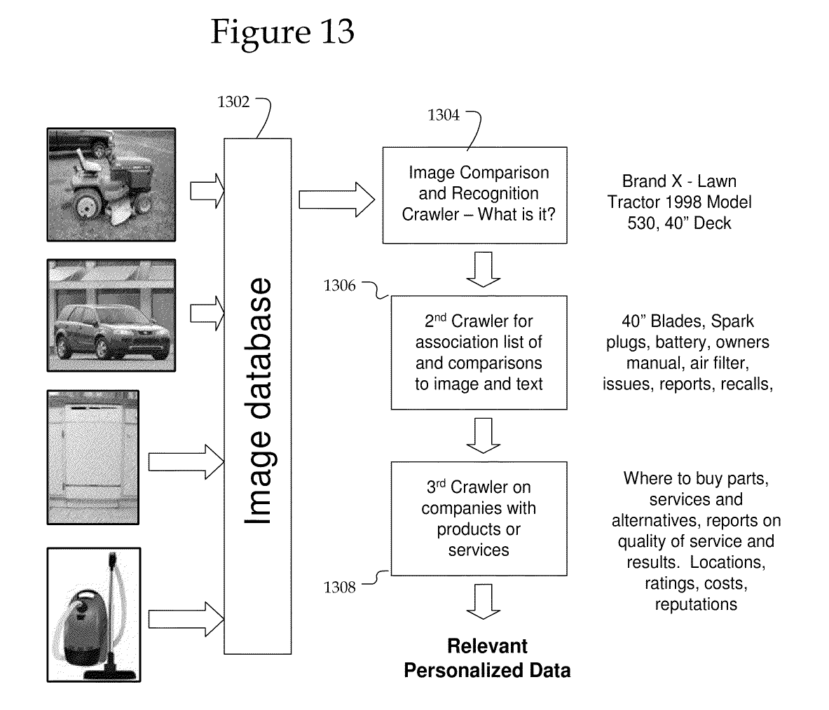

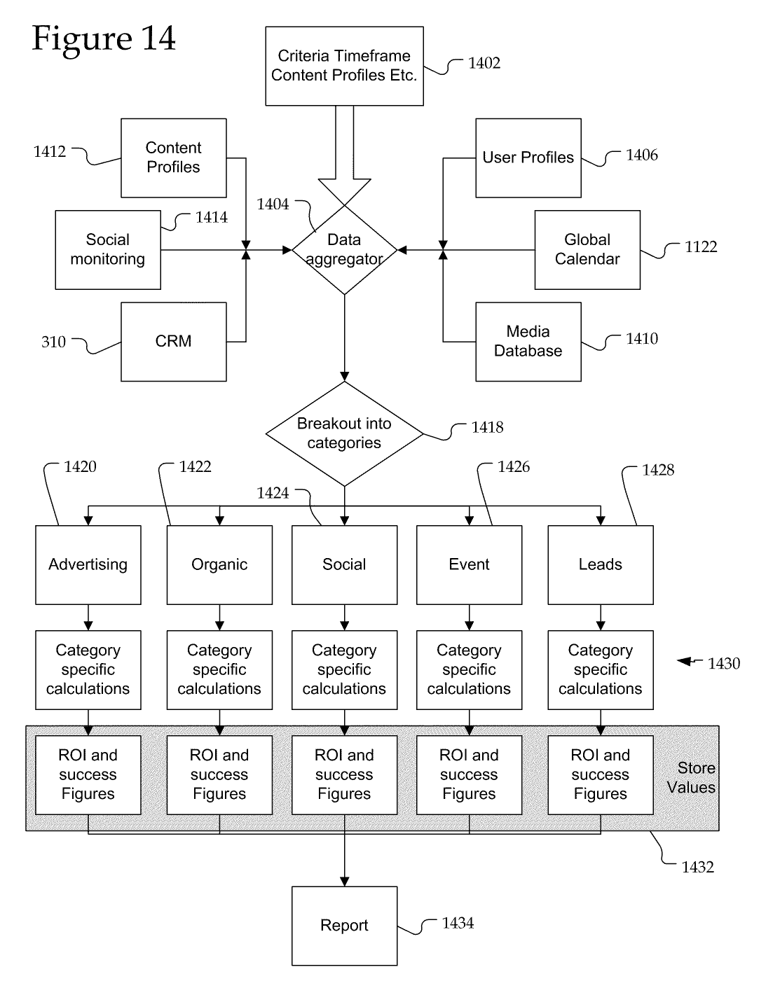

Using the media placement 320, a third crawler search 322 may be used for the media value database 324. The third crawler search 322 may include searches on the sources of data. The media value may be refined in a similar process and updated independently from the media tracking but referenced for financial or lead tracking. The third crawler search 322 may be related to the exemplary image searching described with respect to FIG. 13. The sources may be analyzed based on the search results from the third crawler search 322. This analysis includes the data aggregation and second tier of relevant data 328, which may be used to develop an aggregate score stored in a value/influence database 326. The data aggregation 328 is described with respect to FIG. 14. The value/influence database 326 may include a social value or a sentiment. This represents a deeper analysis and data gathering of information about a particular source. This information was already crawled and a reference list about this source was already built. The third crawler search 322 is used for evaluating the source of where the media or search result comes from. The second crawler search 318 is used for looking at the source and building the CRM database 319 that includes information from a number of sources. The media placement database 320 is generated and created from the second crawler search 318. This information provides the who's and where's of sources and media.

The media value database 324 may also store the costs for appearing with particular sources. For example, a commercial on a major television network will cost significantly more than an online advertisement on a blog. This also relates to the media placement database 320 which includes a measure of the placement. The cost to advertise is likely to be comparable with the “circulation” or “impressions” for a particular source.

In one embodiment, when someone wants to advertise, the cost of that advertisement and the success of such an advertisement will be factors for the media value. The outcome to be determined for any advertisement is the ROI. The success may also include a reputation rating. The amount of influence may vary depending on one's reputation. The question becomes how much should be spent in order to subvert or change or send a positive message to improve the reputation. In one embodiment, overall reputation for a company may be calculated using the following equation:

Reputation_rating=Vision_score+Emotional_score+Products_Score+Service_score+Workplace_score+Performance_score+Social_score.

Each individual score may have a sentiment element and a relevance element for determining relative accuracy. The dictionaries of the grouping or terms monitored may be updated as this returned information is evaluated. It should be noted that reputation for an individual or other entities may include different sub groupings.

The analysis outcomes and results 330 include several factors. For example, the ROI values by area 334, the key influences by region or event 336, the impact by media 338, and the impact event may all be factors for the analysis of outcomes and results 330. Pulling all that data and summarizing it is valuable in order to analyze it and provide the results for reporting 332 and for iteratively updating the ROI by area 334, key influencers 336, impact media 338, and impact by events 340. The value/influence factors stored in the value/influence database 326 may be used with a social value, sentiment, and/or media value to identify sources that are positive and identify sources that are negative. For example, sites, people, media and blogs may have a specific following, and the influence may indicate how many people will see, hear, or follow an event. This base number may be extrapolated as an influencer value and further enhanced when media value is added. This may be used when specific media may have TV, radio, or other outlets. This may expand the scoring when tracked and entered accordingly. Further analysis includes a determination of influence. The key influencers 336 may be helpful for identifying the source or events that can have the highest impact. For example, the key influencers may be certain blogs or other sites that generate a lot of interest on a particular topic. Those key influencers are providing a solid ROI because the return is high. For example, a press release is issued and there is a lot of buzz and hits in Denmark. It is important to identify the source of the buzz. It may be that there may be a single hub (e.g. a Denmark tech site) that started the buzz. This site is a key influencer with a potential high ROI.

The impact or influence of certain advertisements may be low despite an enormous cost. For example, the printed media and getting in the World Series playoffs may not be the best bang for your buck because of the high cost. It may be good for brand placement, but consumer awareness may be non-existent. The impact by media needs to be monitored and tracked. An ad at the World Series with the flip board behind home plate may only be thirty-two seconds of placement. The uptake across all impressions and the buzz may be measured afterwards and it may be minimal. The impact analysis may be part of the reporting 332. This analysis of marketing and public relations is related to monitoring and tracking an image. If a negative article or review is found about one's product, then a response may be necessary if the influence is high enough. This is an example of highly targeted marketing.

The impact analysis may be dependent on the source and the topic. For example, Steve Jobs would have a high influence discussing technology and Michael Jordan would have a high influence discussing basketball. However, if the roles were reversed the influence would be very small. By understanding these roots for particular sources and by characterizing and defining these, a value can be assigned and tracked for different sources, topics, and placements. Measuring an impact for a known site can be defined by their exposure, by number of reads, by the influence of the person that is talking and by who is picking it up and the influences that it has through a network. Being able to track and monitor sources and influence numbers may be helpful in maintaining a positive perception. The crawlers can sweep the net to monitor the text, images, audio, or video that is released about a person, company, brand, or product including a sentiment. The quantitative measurement of impact may be based on popularity (e.g. search results, mentions, pages, etc.) within a network, such as the Internet. The influencer module may identify a relative popularity as it tracks how many people are viewing, republishing or blogging about a monitored topic. Popularity may be a sub-element of influence as key influencers are very popular.

FIG. 4 illustrates the requesting of data 402 for an event and the generation of the reference database 306. The reference database 306 is designed to include the specific monitoring elements for the categories, products, brands, media outlets, blogs, and event calendars that are searched. Event calendars may include specific events and links to the specific media that will follow each respective event. This database may be linked to the marketing including the phrases, terms, images, and target monitoring assets for a campaign. This includes a matching engine 420 for comparing the request data. The text based reference items and the image based reference items are used for the first search crawler 304. Alternatively, the search may include other media types, such as audio, video, or other media. As illustrated, the request data 402 includes text based request data 404 and image based request data 406. The text based request data 404 may include a brand name, events or partners, quotes, or other forms of text. The analysis portion considers the context for the request data 402. For example, a name near “says” is likely to be considered a quote.

The image based request data 406 may include logos in images, logos in videos, markers in images, markers in video, or other forms of images. The requested data may be used for a text based search 408. The text based search 408 provides text pointers and data 410. The text based image search 412 generates image pointers by type 414. The request data 402, the results of the text pointers and data 410, and the image pointers by type 414 are provided for the analysis and comparison of data and images 420. The analysis and comparison of data and images 420 further includes the identification of images and markers aligned with text search, and generates the search report and statistics for the relevant database 422. The text points and data 410 and the image pointers by type 414 are provided for the reference database 306.

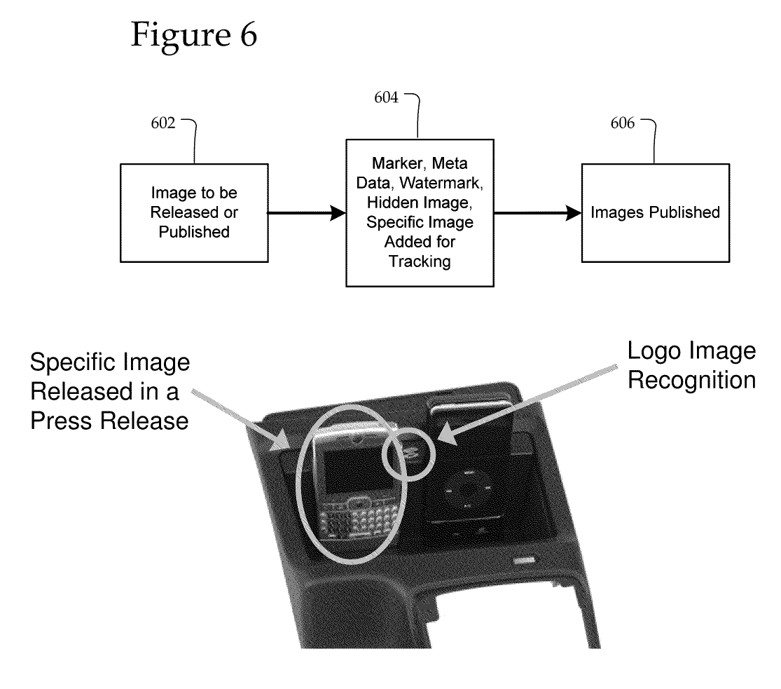

The image based request data 406 may be base line objects that are searched for on the web. The analysis portion looks for context. For example, in speech it can look at context and give more pronounced versions of the speech. It can also look for the context of a quote. The request data 402 may be tracked to identify different sources of the data. The effectiveness of the data may also be measured by analyzing influencers and sentiment. In one embodiment, a text based image search may provide text pointers and data. The image pointers may be identified by type, and may include link pointers for the reference database 306. The analysis and comparison of data and images includes identification of images and markers aligned with text searches that are used for building search report statistics that include where they are found, where they originated, and the propagation through the web. In alternative embodiments, images may be added to the reference database 306 by image searching as discussed with respect to FIGS. 5 and 6.

FIG. 5 illustrates how media and text are analyzed using crawler data. The image search request 406 is provided to a general search list 504 and text & images associated with search 508. The general search list 504 is provided to a web crawler 506 that populates the reference database 306. The general search list 504 may include a list of brands, terms, and/or phrases for providing a relative score that can be monitored over time to monitor history and impact. The reference database 306 is provided to an analysis sequencer 510. The analysis sequencer 510 analyzes images 512, text base quotes 514, video image analysis 516, and video and image marker search 518 for markers. A marker may be a logo or other identifier as discussed with respect to FIG. 6. The analysis from the analysis sequencer 510 is passed for matching data and image organizer images, videos, statistics, links, ISP, ISP links, regions, marker tracking, quote tracking and usage, and image usage statistics 520. The statistics 520 are used for the image and text usage report 522. This report 522 may be used to further build out the request data or reference dictionaries for statistical accuracy.

A marker may be something marked in the image to help identify the image. As shown in FIG. 6, a marker could be the MOTOROLA Q cell phone used in conjunction with the logo. Different product prototypes can be staged with different backdrops. Likewise, different pictures can be staged for a specific press release, a series of communications or a message.

Logo image recognition may be used for identifying different markers. Other markers include watermarks, like a blurred section or a discolored section of the page that where those pixels represent a marker. Merely 10 pixels off in the corner that make up red, green, blue, yellow, orange, yellow-green, red may be a marker. Referring back to FIG. 5, the recognized data may be refined by analysis 520 and new database content may be generated with more relevant data. Based on image or data type, the proper analysis engine is used for video, gif's, pdf's, jpeg's, etc. The match also initiates additional information to be stored for that comparison, such as ISP data, match % or accuracy, client data, reference image and marker linkage, reference text, context and quote data, sentiment data, region and links, view data, use statistics and more.

FIG. 6 illustrates how the text, logo, or image marker of a specific product or characteristic stored in the reference database can be used for specific comparisons. As mentioned above, FIG. 6 illustrates the use of image recognition for identification. In block 602, an image is selected for release or publication. A marker is added to the image for tracking in block 604. The image is published in block 606. As shown, a logo may be used for image recognition. The MOTOROLA Q phone may act as a marker with the logo. The marker may include meta data, a watermark, a hidden image, or a specific image used for tracking.

An image matching algorithm may be used that can find known user-provided images in large (or perhaps open-ended) sets of images on the internet. In particular, user's images might be the company's proprietary or marketing materials (photographs, drawings, logos) and the company may be interested in their use, spread or distribution on various relevant websites. The algorithm may operate in the presence of possible significant image modifications that are often applied when images are re-used for different contexts. For example, modifications may include image resizing/rescaling, trimming, compression, inserting (whole or a part) into other images and vice versa, as well as color/contrast editing. Besides invariance to the above factors, the should ideally matching the speed of downloading the query images from their host sites. This implies the typical processing time on the order of one second or (substantially) less per image, independently of the number of user's image to compare against.

The framework may involve extracting a signature (e.g., a set of features) from each image, invariant to the covered types of image transformations. Each feature may be extracted in invariant manner and assigned an invariant descriptor that is stored in (or queried against) an index/search structure. Similar images must have similar features (with similar descriptors) in similar locations. Two images are matched, and the mapping between them is found, if they have a sufficient number of matching features consistent with that mapping.

The recognition technology may be implemented through indexing and query. In the indexing mode, the user's set of images are processed and converted into an index structure optimized for search efficiency. This procedure may be performed once, offline (at significant computational cost), but the resulting index enables fast online operation of the query mode. In query mode, the feature signature of the query image is extracted and tested against the index. This identifies all the candidates among the indexed images that have a number of features matched with those in the query image. Each of those candidate images are matched against the query image using a robust voting-style procedure to find the mapping (scaling, shift and trimming) between two images that is consistent with the highest number of matched feature pairs. If the latter number is sufficiently high, the candidate is considered valid, i.e. the query image (or its fragment) is considered found in the corresponding indexed image.

The image processing (feature) signature extractor—may be applied identically in the both indexing and query modes. It may include any of three main sub-blocks: generating scale-space representation of the image; detecting points of interest (or feature points) at different scales; and generating feature descriptors (multi-dimensional vectors that describe the local image pattern) at each detected feature point. A scale-space representation may a pyramid of filtered and sub-sampled versions of the original image, designed to produce more or less the same results in case the input image was resized. A feature detector may be designed to maximize repeatability, i.e. to find more or less the same points of interest in case of various modifications of the input image. Finally, feature descriptors may be designed to optimize the trade-off between invariance and distinctiveness: the descriptor vector may be distinct for unrelated points but may be similar for the corresponding points under various covered modifications of the image. In one embodiment, the algorithm is based on Harris-Laplace feature detector and SIFT feature descriptor. This implementation may utilize algorithmic reductions, achieving higher speeds and smaller memory requirements, at minimal cost to recall-precision performance.

A feature index may represents a metric tree structure, built in a top-down framework, with relatively large branching factor (˜8-16) and low depth (˜5-6). Starting from a root node holding all the features of the indexed images, each node may be split into a fixed number of branches using k-means clustering algorithm on its feature descriptors. Each feature may be assigned to the closest node (corresponding to its cluster) and all the other branch nodes distance to which is not significantly larger than to the closest node. The clustering and branching process may continue until the number of features in each node is below a certain threshold. In the finished index, each feature may be present in multiple leaf nodes. This architecture implies a larger index but faster queries and each feature from the query image is propagated straight down the tree to a single leaf node, which may include all the indexed features that are likely to match it.

Candidates with a sufficient number of matched features may evaluated in an image matching module. To find the best mapping, a variant of a standard two-stage process—random sample consensus (RANSAC) followed by nonlinear optimization—may be utilized. Pairs of matching features may be chosen at random and used to estimate the mapping parameters (scale and shift) between the two images. The mapping with the highest support among the rest of the features is chosen and later fine-tuned through nonlinear support maximization. If the resulting support is sufficiently high, a detection may be reported. To achieve a sufficient level of support there may be a significant proportion of features matched between images in geometrically consistent way.

In addition, to image/logo matching, the system may also match audio. FIG. 7 illustrates an audio analysis using audio patterns. Just as image recognition may be used for locating and identifying images, audio recognition may also be used for identifying known audio. As discussed, the recognition of either images or audio may be used for identifying the distribution and/or impact of that image/audio. For example, image or audio recognition may be used to identify the number of sites that use that image or audio. As shown in FIG. 7, the audio patterns for a dictionary of words may be used to scan files (e.g. video, music, ebooks etc.) and to find places where these words are used in an audible context. Using the term apple, all uses of apple (e.g. movies) can be monitored to determine the general sentiment of people's use of the word apple. Theoretically, every available use of the word apple can be recorded and indexed, such as its use in the movies.

The audio analyzer described in FIG. 7 may be part of the data and media analysis 308 described with respect to FIG. 3a. This may also include having every reference that is in text indexed. Using this system an input of a quote may result in each use of that quote in the movies or in books. The analysis provides the ability to search into a video and look for terms and index those terms. A dictionary may be built with these different words. Based on recognition, there may be indexes of an audio segment with the different contexts. For example, an analysis of the Today Show may include a review for the mentioning of any desired term, such as a product name. The Today Show can be monitored to determine when they mention a product of interest, which functions as brand awareness. This analysis has more value when used for tracking a particular product. The tracking may be used for identifying those sources or contacts that are most influential.

FIG. 8 illustrates references between languages, images, text, and audio. As shown in FIG. 8, a web search for a particular topic/concept (also referred to as a dictionary item) can cover multiple forms and languages. For example, apple can be searched through audio, text, or images, or using different languages. Request data 304 may be pre-linked and grouped to the campaign assets, timing, and categories. A series of communications and partners and terms may be linked to images and other assets. The system may then build a list of pointers to locations where these dictionary items are used. There may be a dictionary of images, a dictionary of languages, a dictionary of text, and a dictionary of images. A user could look up apple across the internet and it would pull all the text versions of apple used in every language. The dictionary in FIG. 8 is actually a 3-D database. Alternatively, individual databases may be used for the language, audio, text, or image. Using the text, one can find all the different languages. When the text is known, all the different languages may be accessed. In one example, the text can go off into 20 languages and 20 different audio patterns and the image can go off into multiple images of an apple. This may be part of the next generation of the web where when you move through the web, the media is also going to move through the web as opposed to just residing in a singular place.

FIG. 9 illustrates database comparison to an initial set of data. The processing illustrated in FIG. 9 may occur within data & media analysis 308 and/or the comparative database 310. The initial set of data may be web data 902, such as video 904, images 906, and/or text 908. The video data 904 may include an association with a watermark, markers, an embedded URL, or a text algorithm tag 910. The image data 906 may include an association with a watermark, logo, markers, a text algorithm tag, or metadata 912. The text data 908 may include an association with a key copy, URL's or a text algorithm tag 914. The markers are validated 916 to check their uniqueness. If they are not unique, then the process is run again because the data would not be able to identify relevant documents. If it is unique, the benchmark or original data 918 is stored matched. The data is compared and based on the comparison, the original content, content data, outlets links, match data may be stored. The length of time to track 920 is used. The tracking may be continuous, and for better results a time period may need to identify for data comparison. For example, the CES show may be considered a period of time that is timed and tracked. The period of tracking can be user defined or initiated by RSS feeds.

Additional data is collected from RSS feeds 922 and other known sources 924 that are provided back for the store and compare 918. This generates the reference database 306 and the report criteria date range 930, which generate the dashboard visualization 932. The dashboard visualization may provide statistics regarding hits and impression, as illustrated in FIG. 16. The dashboard visualization may be similar to a stock ticker that displays past and current traffic and/or popularity. It may also include recent events that may be influencing the popularity. The data can be recorded in the relevant database 330 to further generate a measure of the success or ROI of an event. The relevant database 330 is built from an analysis 928, which also provides audience search usernames for the known sources 924. The audience search 926 may log usernames of an audience or search other outlets for usernames that are used for demographic information. The CRM database may also provide names, addresses, companies, titles, and other data to allow further comparisons for relevance using this data. A target account on the CRM may provide regional information and areas of priority. The audience search data 926 may be provided for the organization and compare 918 of data.

FIG. 10 illustrates the use of a contact relationship management (“CRM”) database 319. In particular, CRM provides additional value by targeting content to a user or business by using the CRM database 319 to record information about contacts. The rerouting may be performed by an internet protocol (“IP”) address or with user profile data. The tracking of a particular user may be used to target relevant material based on the content of the CRM database 319. The targeting may include displaying a version of a website based on the data in the CRM database for that user. For example, if the user runs a blog dedicated to being green and environmentally friendly, the displayed site can display materials emphasizing the owner's commitment to the environment. Further each participant of a business may be held to specific rules of that business. For example, each respective user in the CRM tool may be associated with Facebook accounts, Twitter, websites, blogs, user IDs, and/or other data that may be useful in tracking compliance or interests.

A user visits the site in block 1002 and a determination is made whether there is a CRM cookie in block 1004. If there is no cookie, the IP address is obtained in block 1006. The IP address is checked in the CRM database in block 1008. If the IP address is not present in the CRM database, it is added to the system including a cookie. Variables 1010 are then measured for the user and if there is specific content available for that particular user, a targeted site is displayed for the user at block 1012. If there was no matching IP in the CRM database, then the user is directed to the standard site in block 1014 and the site statistics, contact info, and/or variables are tracked in block 1016. This user info is stored in the CRM database at block 1008. At block 1004, if there is a cookie, that cookie will identify the targeted site to be displayed to the user.

In one embodiment, this targeting may be used for companies that are included in the CRM. The targeting knows when a particular company is visiting the site. This can be used for a competitive analysis or for recruiting/targeting business from a company. For example, if members of a company look at certain products, those products can be targeted to all employees of that company.

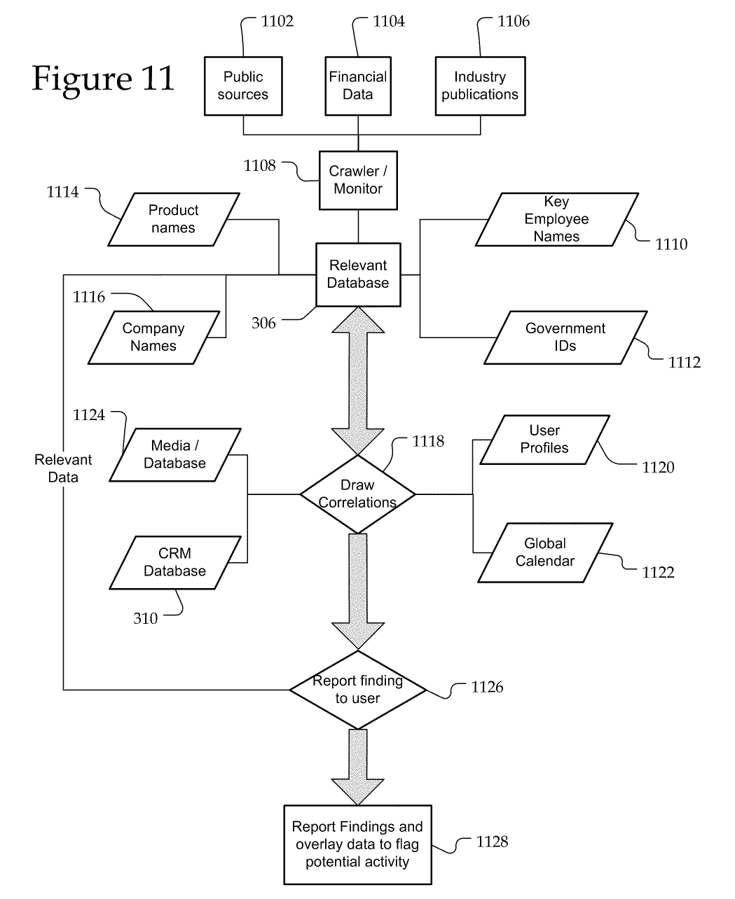

FIG. 11 illustrates the resources used to validate social expertise, and CRM data for valuing and influence. A score using categories (such as those discussed above) and sub-elements may be valued based on importance by a business or business line. A product concept versus a product may be validated by seeing the SKU and FCC listings for example. Having access to this data may provide combinations that produce valuable flags and triggers that may need to be tracked manually. Additional data including public sources 1102, financial data 1104, and industry publications 1106 are provided to the crawler/monitor 1108. Public information may include government agencies and other organizations, such as the ECD, FCC, USPTO, CGP, NCJRS, and CRSP. This aspect of the crawler gets all data related to a user, contact, blogger, media contact or company and pulls the statistics. This data and related statistics form an opinion and valuing of each contact, company, blogger or related impression. For example, patent filings may indicate a company's current technology pursuit. The FCC may have recent disclosures on a product. Financial documents 1104 and industry publications 1106 also provide clues regarding a person or a company's pursuits that may be stored in the CRM database 310. For individuals, criminal databases may be checked as well. The web, including social networks may provide additional public data for putting together a profile. For people with the same name, matching may be used to identify the right individual.

This crawling is used to populate the relevant database 306. In addition, key employee names 1110, government ID's 1112, product names 1114, and company names 1116 may also be used to identify relevant data. Tracking involvement in patents, products, and technologies may be a sign of CDA compliance and potential breach of contracts. The relevant database 306 may be used to establish correlations 1118 with the media database 1124, the CRM database 310, user profiles 1120, and the global calendar 1122. The correlations are reported to the user 1126. The reported findings may be tracked to flag potential activity 1128.

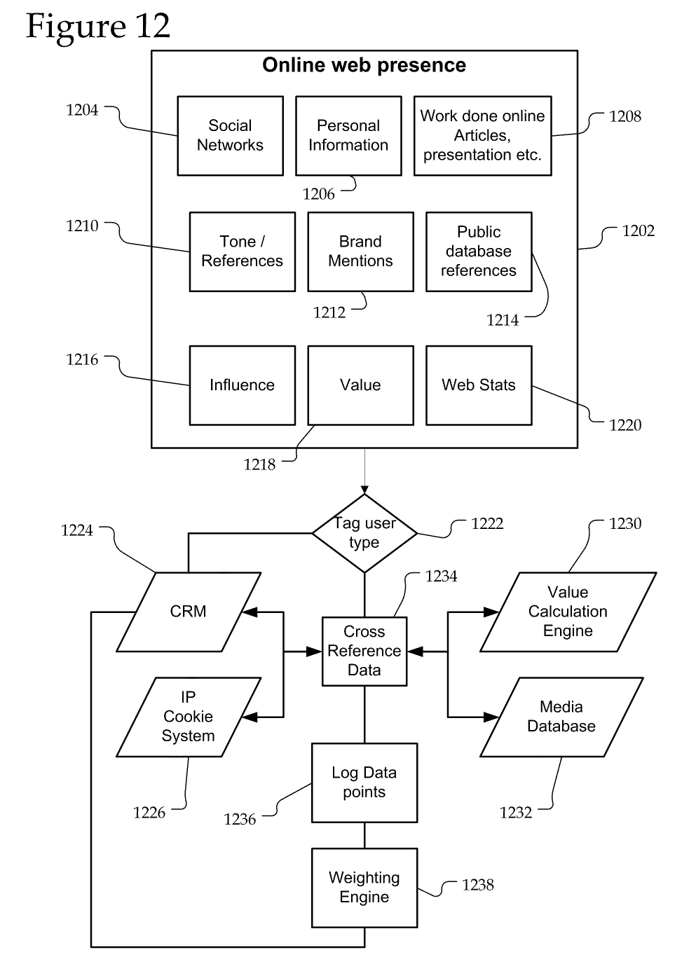

FIG. 12 illustrates the collection, storage, and valuing of contact information. The valuing engine 1236 may automatically determine the value for each contact/business. In one example each contact/business is stored in the CRM database 310. The online web presence 1202 is identified, which includes social networks 1204, personal information 1206, articles/presentations 1208, tone/references 1210, brand mentions 1212, public database references 1214, influence 1216, value 1218, and web stats 1220. This data is used to tag user type 1222, which is cross referenced 1234 with the CRM 1224, IP cookie system 1226, value calculation engine 1230, and the media database 1232. The cross referencing 1234 is used to log data points 1236, which are used in the valuing engine 1238. Social networks 1204 may include Facebook, MySpace, Twitter, and/or other social networks. Personal information 1206 may include names, addresses, usernames, and other related information. Articles and presentations 1208 may include content related to topics and uses and to the presenter or personal information. Tone and references 1210 may relate to the sentiment score and content or context. Brand mentions 1212 may be a list of the references that relate to the brand. Public database mentions 1214 includes public records, patents, criminal records, tax forms, census data and any other data related to the user. Influence 1216 may be a relative list or influence table that is a secondary search that scores each user or site for its relative influence. IP cookies 1226 may be another link to the personal data that can be tracked on a website. The value calculation engine 1230 may be a series of algorithms and links to form decisions and scores based on connecting disparate data and scores. The media database 1232 may include several pieces of data, such as the links, the reporters, or bloggers, and secondly it may include the influence and media value for each. The media database 1232 may keep a history of all media links or actual data to formulate a longer term perspective and history. Each contact may be valued based on all the information in the online web presence 1202. Economics, job of the contact may influence the value. The report from the valuing engine 1238 provides details on influence. For example someone with thousands of FACEBOOK friends would have a significant social contacts influence. Economics factor may be significant for the value.

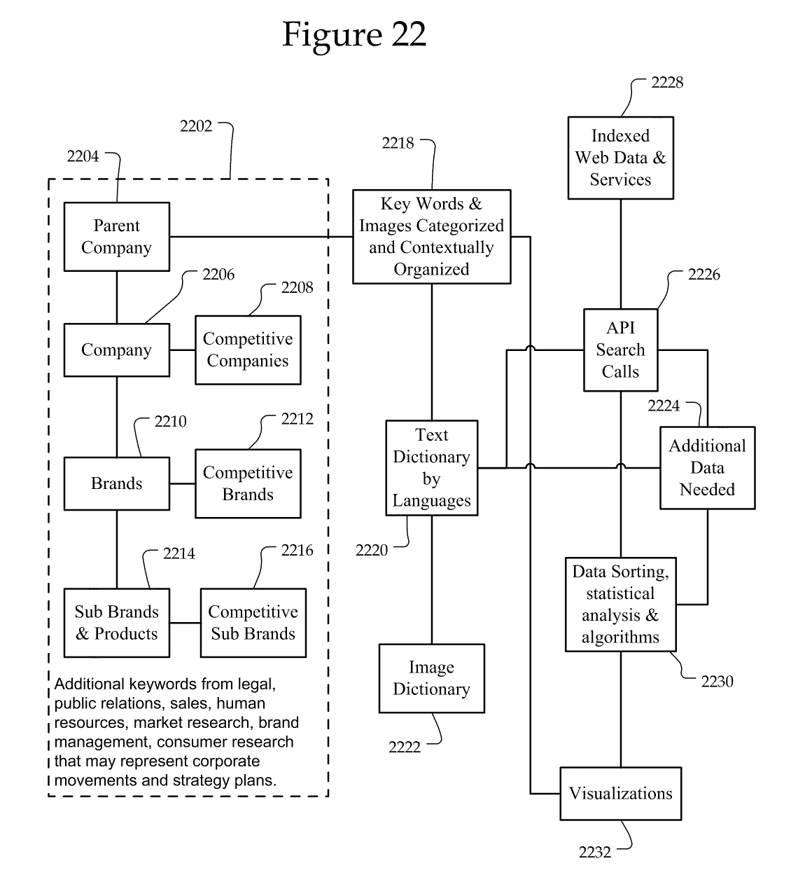

The valuing engine 1236 may statistically evaluate each keyword used in a search. For example the keyword may be evaluated as it relates to interest as discussed with respect to FIG. 22. The evaluation may use starting reference data to monitor the system. That data may then be used to calculate value using mentions, sentiment, influence numbers, and/or media value. This may be an initial pass of value but can become more complex based on business needs. This evaluation provides a base set of relative data for historical tracking and may also include the categories discussed and additional qualifiers deemed needed by the business opportunity. The evaluation may allows terms and returned data to represent a statistical relevance. Rather than a user setting the value amount, the system may show the relevance of each keyword and the context between the usage of these keywords. For example, the valuing engine 1236 may analyze a series of search configurations statistically analyzing the data to show which terms have statistical relevance to the information the system seeks to retrieve. Based on the returned statistical information each search term it may be assigned a true value as it relates to the statistical value.

FIG. 13 illustrates how images can be converted into useful data. For example, pictures of household items that have been purchased may be converted into valuable and useful data regarding that item using powerful web tools to gather information for the user based on that picture. Pictures of items that are important may be used for identifying relevant items or items that can be associated with the user. The image database 1302 stores relevant items and may be part of the reference database 306 or the comparative database 310. The image database 1302 could then be used to identify replacement parts for a photographed product.

In order to identify relevant data or information about one's stored images, an image comparison and recognition crawler 1304 may perform a search with another database in block 1306. The second crawler generates an association list including comparisons to images and text. The third crawler collects company information for products and services as in block 1308. In an alternate embodiment, the second and third crawlers may be combined. A second crawler may be used to allow dynamic content to be search on the next pass allowing the dataset to grow organically. This may be used to optimize content accuracy. The initial crawl may reveal links that may change the search terms. A dynamic unique word or phrase list may be used to further qualify how people are talking and track that as a new dynamic search set with several sub-elements of the original search. It may also be different sets of data by people, media, categories and other relative data for specific concerns, interests and analysis. The result of the last crawl is relevant personalized data. The relevant personalized data may include a personal web page or a personal search engine. It may include relevant personal information for the user. The information that is presented is based on the relevant personalized data. In one example, that data may include a previously purchased product that can be used to identify replacement parts for that product. In another example, the system may provide the ability to identify sellers that carry replacement parts. This personalization acts as a local version of a search engine that may reside on the client side.

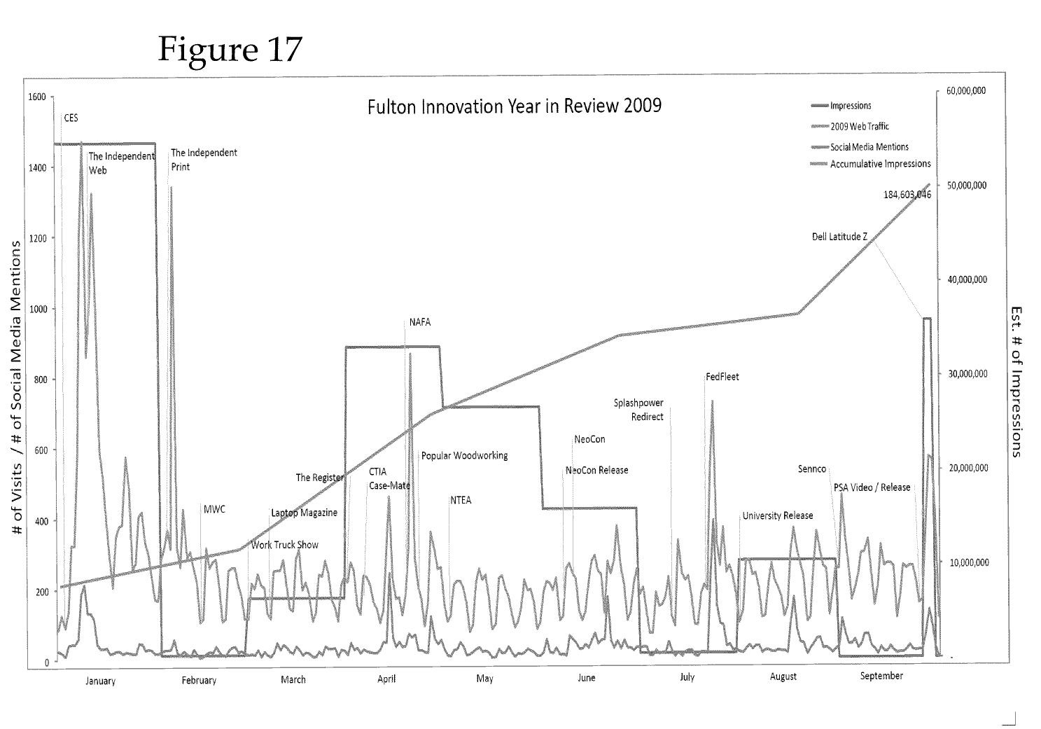

FIG. 14 illustrates the return on investment (“ROI”) engine for calculating a ROI for certain sources, such as advertisements. This system may look at a day or an annual marketing effort established by a criteria timeframe and content profiles in block 1402. The data aggregator 1404 aggregates the data and looks for a positive representation to create the potential for value. The data aggregator 1404 receives data from user profiles 1406, a global calendar 1122, a media database 1410, content profiles 1412, social monitoring 1414, and the CRM database 310. The system may then categorize the data 1418 and calculates the groups. The groups may include advertising 1420, organic 1422, social 1424, event 1426, and leads 1428. The data aggregator may uses data links in time, scores, and counts to store a historical view of the data that can be re-analyzed if the algorithms change. This may be a raw form of the data recalculated to allow further analysis. The dictionaries, algorithms, and terms may also need to be saved to allow relevance and track specific changes for a better understanding of data retrieved. The actual data may be stored as future links that may be deleted. This data set may be used to calculate ROI and understand complex marketing or consumer research decisions over time and events. The advertising group 1420 may include the value of advertising as calculated with a “cost per thousand” model to define relevance or popularity with a user. The relevance/popularity may determine the pricing for advertising media. The organic group 1422 may include stories being organically spread across the web to other sites in one example. The social grouping 1424 may include social data such as amount of social network site fan bases and followers to determine social influence. The event grouping 1426 may include events such as a “Consumer Electronics Tradeshow” where specific impressions may be attributed to media involved with the event. The leads grouping 1428 may include leads that have been generated through CRM activities and may be attributed to an event through lead self selection or a determination based on a date range. In other words, leads generated during the same date range as a trade show where the user identified that “trade show” was the source of the connection. The categories include category specific calculations 1430. Based on those calculations, the ROI and success 1432 may be determined and reported 1434 for each category. The report 1434 may contain each media type and outlet, time or video or article size, relative cost of placement and a total value. The values used to calculate the ROI report may also be see in FIG. 17 for the accumulated counts over specific events with the numbers being multiplied by the influence and media value.

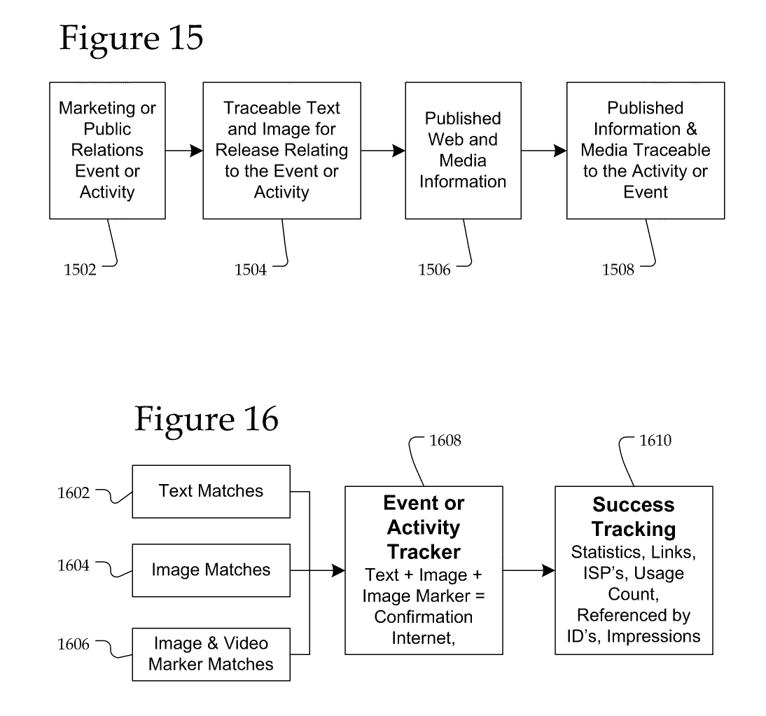

FIG. 15 illustrates how text and image reference information is seeded into media releases and then tracked via the reference database 306 for context. In block 1502, there is a marketing or public relations event or activity. In block 1504, traceable text and images are generated for an event or activity, such as a product release. Traceability may be seen in FIG. 17 and shows events linked to media. Although this example illustrates media, in other embodiments, it may be linked to other events like FCC announcements, patents, and other events. In block 1506, the web and media information are published. In block 1508, the published information and media are traceable to the activity or event

FIG. 16 illustrates items in context can be used to track the success of an event or series of events. The text is matched in 1602. The image is matched in 1604. Image and video markers are matched in block 1606. The event or activity tracker 1608 includes text, image, and image markers to confirm a match. The success tracking 1610 tracks statistics, links, ISP's, usage count, referenced by ID's, and impressions. An example of tracking the success can be seen in FIG. 17.

FIG. 17 illustrates a visualization of impact analysis. The cumulative impression curve tracks the ongoing activity rather than the instantaneous numbers. In particular, the cumulative curve is the number of ongoing impressions, while the other curves are instantaneous values of impressions, web traffic, and social media mentions. The sentiment may include negative and positive sentiment indicator. Negative influence in impressions has a negative impact to the cumulative numbers multiplied by the influence factor of that outreach in those impressions. If the influence is greater, the impact is greater. If the influence is less, the impact is less. In other words, a source that has been found to have a very high impact will have a higher influence factor. This influence and measurement of data can be used to measure the influence of particular sources. Reputation issues may be tracked in terms of cost or impact. This may be used to determine ROI for certain marketing costs.

The chart may provide a way to determine which events are most successful. The success may be measured based on web hits, impressions, or social media mentions. In other embodiments, additional analytics may be measured. This data can be correlated by comparing any peaks or valleys with events, articles, or other discrete events. In one example, a small blog might publish an article and the impressions may not vary greatly because the small blog has a low influence factor. Conversely, a large blog may post a positive article and the impressions may spike greatly for the next several days. This positive influence may be great because the large blog has a high influence factor. The impact analysis being described may help to maximize exposure of as many people as possible in a positive way, so that a positive message is conveyed. The most influential and positive sources/events can be targeted with marketing dollars, while either non-influential or negative sources/events can be avoided.

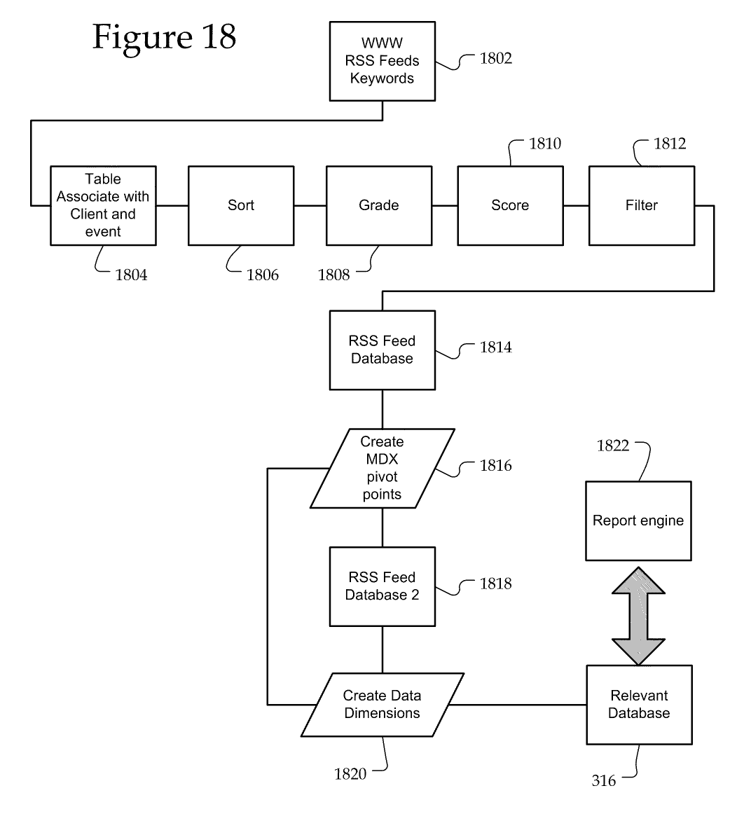

FIG. 18 illustrates a process for collecting additional data. The data can be identified by RSS feeds 1802. For example, the additional data may be one or more RSS feeds which are parsed automatically to create other predefined relevant feeds that are generated by events from identified sources. Using RSS feeds provides an easy mechanism to determine if any information has changed. A table associated with a client and an event 1804 is generated based on the keywords from the RSS feeds 1802. Each RSS feed is processed by a sort 1806, a grade 1808, a score 1810, and a filter 1812 to generate an RSS feed database 1814. The data may be parsed in such a way to generate multiple dimensions based on the reporting needs of the user. In one example, this data may be organized as it relates to FIG. 22 so that each respective aspect of an organization includes the relevant data pertaining to that aspect of the search. MDX pivot points 1816 are created for reviewing the data in a different ways. The pivot points 1816 feed a second outlet RSS feed database 1818. The data dimensions 1820 are established and can go back to the MDX pivot points 1816. From the data dimensions 1820 the relevant database 316 is populated and a report engine 1822 can generate quick reports.

The RSS feed databases 1814, 1818 may be part of the reference database 306. With the RSS feed a user can look for a certain topic, but that data is received in a random fashion. The RSS feeds happen whenever those events are changing or happening whereas your crawler can go out at a pre-determined timeframe and just get that information. The RSS feed databases are processed at a different interval. The data may be organized to stack in multiple dimensions and flow outward in these directions. In one example, as shown in FIG. 22, each respective interest may start to organize specific interests around a search. For example, a product search in a competitive space may return important data for research and development. A legal related search may include additional search terms that can trigger specific disclosures that are of interest. This may be amplified by reproducing each additional dictionary by language, adding images, and adding sound patterns.

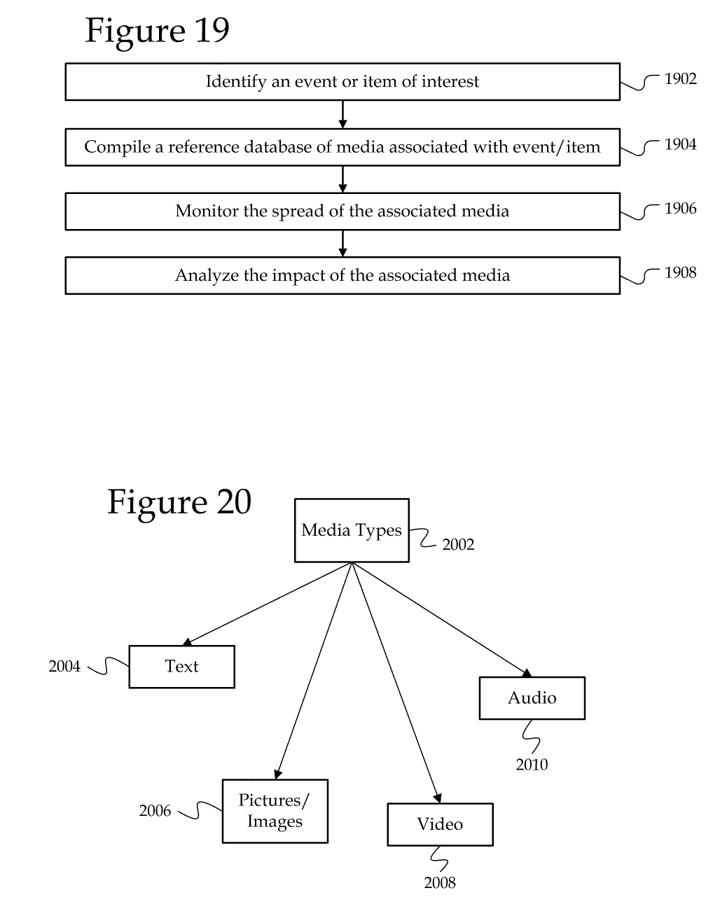

FIG. 19 illustrates an exemplary process. The exemplary process may be considered to be a more direct and specific source for data collection. In block 1902, an event or item of interest is identified. In block 1904, a reference database is compiled that stores media associated with the event or item. In block 1906, the spread of the associated media is monitored or tracked. The impact of the associated media is analyzed in block 1908.

FIG. 20 illustrates exemplary media types that may be tracked and/or analyzed. The media types 2002 include text 2004, pictures or images 2006, video 2008, and audio 2010. The media types 2002 represent any item or event that may identified. In one embodiment, digital tags are used to track media.

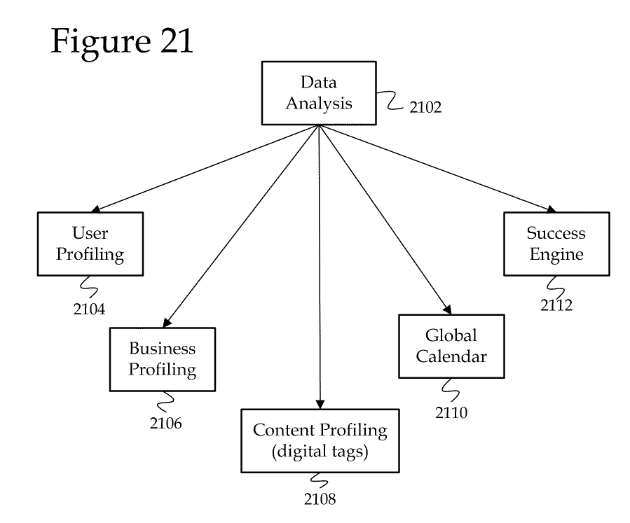

FIG. 21 illustrates exemplary data analysis. The data analysis 2102 includes user profiling 2104, business profiling 2106, content profiling including digital tags, a global calendar 2110, and a success engine 2112. This is designed to qualify content, timing and potential sources and then track the success of that event and content proliferation.

FIG. 22 illustrates development of common terms for a corporation. In one embodiment, FIG. 22 illustrates the population of the reference database 306. An organization 2202 may facilitate a common list for product, research, brand, corporate interests, human resource interests, financial tracking and other relevant information to gather relevant information in context of the search and interests. The organization 2202 may include the parent company 2206, the companies 2206, competitor companies 2208, brands 2210, competitive brands 2212, products 2214, competitor products 2216 or people with the organization or organization competitors. The organization 2202 may generate keywords or images categorized and contextually organized 2218. These keywords 2218 may be generated from a text dictionary 2220 of languages and an image dictionary 2222. The text dictionary 2220 may receive additional needed data 2224 from API search calls 2226, as well as data sorting, statistical analysis and algorithms 2230. The API search calls 2226 may include indexed web data and services 2228 and the data sorting, statistical analysis and algorithms 2230 may include visualizations 2232 connected with the keywords 2218.

In one embodiment, a method creates and utilizes a user profile by receiving a request for access to a website, checking for a cookie from the website, obtaining relevant content from cookie and providing a targeted version of the website based on the relevant content when the cookie is present, checking the IP address and comparing with a contacts database when no cookie is available, receiving the relevant content from the contacts database when the IP address is located in the contacts database when no cookie is available, monitoring the user and clicks to generate a user profile to be stored in a website cookie when no cookie was previously available and there was no profile in the contacts database, further wherein information from the user profile is stored in the website cookie, and utilizing the cookie to update the website cookie.

In another embodiment, a relevant database is generated by receiving a topic, performing a first crawler search using the topic to generate a reference database, comparing the reference database with a comparative database that includes more relevant content, wherein the comparative database comprises content associated with the topic, client, event and generating the relevant database from the comparison of the reference database with the comparative database, wherein the generation comprises a refinement of the reference database based on the comparison with the comparative database.

In another embodiment, an impact for media is determined by identifying the media to be tracked, storing the identified media in a reference database, comparing public sources with the stored media, identifying locations including the stored media based on the comparison, and analyzing the locations to determine a success of the locations and of the stored media.

In another embodiment, a social impact for a source is determined by creating a reference database from the web using a first crawler, creating a comparative reference database with images, markers, text, quotes, or context, analyzing the comparative reference database and the general reference database, identifying relevant data based on the analysis, determining, using a second crawler, a source of the relevant data for a social contacts database, searching, using a third crawler, for information on each of the sources from the social contacts database, determining a social value or influence for each of the sources based on the search with the third crawler, and adding the social value or influence for each of the sources to a media placement database.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for determining a social impact of a source comprising:
creating, using a first crawler, a reference database from the web;
creating a comparative reference database with images, markers, text, quotes, or context;
analyzing the comparative reference database and the reference database;
identifying relevant data based on the analysis;
determining, using a second crawler, a source of the relevant data for a social contacts database;
searching, using a third crawler, for information on each of the sources from the social contacts database;
determining a social value for each of the sources based on the search with the third crawler; and
adding the social value for each of the sources to a media placement database.

2. The method of claim 1 further comprising utilizing the media placement database to pursue sites with a higher impact.

3. The method of claim 2 wherein the impact is determined by popularity of the source.

4. The method of claim 3 wherein the popularity comprises at least one of a number of search results, a number of mentions, or a number of pages resulting from a search.

5. The method of claim 1 wherein the relevant data comprises at least one of text, images, video, or audio.

6. The method of claim 1 wherein the social value comprises a return on investment (“ROI”).

7. The method of claim 6 wherein the ROI is calculated using a number of impressions multiplied by an influence factor.

8. The method of claim 1 wherein the social value comprises a sentiment calculation that divides positive mentions by total mentions.

9. The method of claim 1 wherein the source comprises an event to be analyzed, wherein the event comprises at least one of a product, show, press release, article, or web page.

10. The method of claim 1 wherein the reference database comprises elements to be monitored, further wherein the elements comprise at least one of terms, phrases, images, audio, or other target monitoring assets as part of a campaign.

11. A non-transitory computer readable storage medium having stored therein data representing instructions executable by a programmed processor for generating a relevant database, the storage medium comprising instructions operative for:
receiving a topic;
performing a first crawler search using the topic to generate a reference database;
comparing the reference database with a comparative database that includes more relevant content, wherein the comparative database comprises content associated with the topic, client, event;
generating the relevant database from the comparison of the reference database with the comparative database, wherein the generation comprises a refinement of the reference database based on the comparison with the comparative database.

12. The computer readable storage medium of claim 11 further comprising:
collecting data through RSS feeds for generating the reference database.

13. The computer readable storage medium of claim 11 further comprising
generating a contact relationship management database.

14. A method for determining an impact from media comprising:
identifying the media to be tracked;
storing the identified media in a reference database;
comparing public sources with the stored media;
identifying locations including the stored media based on the comparison; and
analyzing the locations to determine a success of the locations and of the stored media.

15. The method of claim 14 wherein the media to be tracked comprises media associated with an event or product.

16. The method of claim 14 wherein the public sources and the locations comprise data or pages available over the Internet.

17. The method of claim 14 wherein the success comprises an ROI, or is based on an analysis of views.

18. The method of claim 14 wherein the success comprises page views when the locations are web pages.

19. The method of claim 14 further comprising generating a dashboard visualization that provides a visual display of impressions or web traffic.

20. The method of claim 14 further comprising generating a contact relationship management database.

21. A non-transitory computer readable storage medium having stored therein data representing instructions executable by a programmed processor for generating a targeting database, the storage medium comprising instructions operative for:
receiving a request for access to a website;
identifying a source of the request for access;
monitoring and tracking requests and behavior from the source to obtain variables about the source;
adding the variables for the source to the targeting database;
utilizing the stored variables in the targeting database for the source to provide a targeted site in response to future requests from the source for a particular site, wherein the targeted site is a modified version of the particular site that is tailored based on the variables for the source.

22. The computer readable storage medium of claim 21 wherein the source is identified based on a cookie or an IP address.

23. The computer readable storage medium of claim 21 wherein the variables for the source include a type of business in which the source operates, further wherein the targeted site is customized based on a comparison of the particular site with rules for that type of business.

24. The computer readable storage medium of claim 21 wherein the variables for the source include information from public websites including blogs or social networking sites.

25. A method for creating and utilizing a user profile comprising:
receiving a request for access to a website;
checking for a cookie from the website;
obtaining relevant content from cookie and providing a targeted version of the website based on the relevant content when the cookie is present;
checking the IP address and comparing with a contacts database when no cookie is available;
receiving the relevant content from the contacts database when the IP address is located in the contacts database when no cookie is available;
monitoring the user and clicks to generate a user profile to be stored in a website cookie when no cookie was previously available and there was no profile in the contacts database, further wherein information from the user profile is stored in the website cookie; and
utilizing the cookie to update the website cookie;

26. The method of claim 25 further comparing the user data with a reference database to identify relevant data when the IP address is not located in the contacts database and when no cookie is available.

27. The method of claim 25 wherein the user profile comprises at least one image and the image is compared with stored images to determine if it matches and is relevant.
